(19) United States
(12) Patent Application Publication
(10) Pub. No.: US 2025/0132761 A1
(43) Pub. Date: Apr. 24, 2025

(54) LASER SENSOR ARRAY

(71) Applicant: QUALCOMM Incorporated, San Diego, CA (US)

(72) Inventors: Khosrov DABBAGH SADEGHIPOUR, Cork (IE); Hari RAO, San Diego, CA (US); Fabrice MARINET, Chateauneuf-le-Rouge (FR); Keith Anthony O DONOGHUE, Carrigaline (IE)

(21) Appl. No.: 18/492,657

(22) Filed: Oct. 23, 2023

(51) Int. Cl. H03K 19/0185; H03K 17/22; H03K 19/003

(52) U.S. Cl. CPC H03K 19/018507; H03K 17/223; H03K 19/00361

(57) ABSTRACT

Systems and techniques are provided for sensing light. For example, a process can include obtaining an active state of a reset signal at a reset input node of an electrical component. The process can include in response to obtaining the active state of the reset signal, latching a voltage of an output node of the electrical component at a first voltage and latch a voltage of a cross-connected node of the electrical component at a second voltage. The process can include obtaining a photocurrent generated by a photosensitive element coupled to at least one of the cross-connected node or the output node. The process can include, in response to at least one of the cross-connected node falling below a first threshold voltage or the output node rising above a second threshold voltage, latching a third voltage at the output node, the third voltage being different from the first voltage.

### FIELD

Aspects of the present disclosure relate to systems and techniques for providing laser sensor arrays.

### BACKGROUND

Computing devices often employ various techniques to protect data. As an example, data may be subjected to encryption and decryption techniques in a variety of scenarios, such as writing data to a storage device, reading data from a storage device, writing data to or reading data from a memory device, encrypting and decrypting blocks and/or volumes of data, encrypting and decrypting digital content, performing inline cryptographic operations, etc. Such encryption and decryption operations are often performed, at least in part, using a security information asset, such as a cryptographic key, a derived cryptographic key, etc. Certain scenarios exist in which attacks are performed in an attempt to obtain such security information assets. Accordingly, it is often advantageous to implement systems and techniques to protect such security information assets.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Disclosed are systems, methods, apparatuses, and computer-readable media for providing laser sensor arrays.

According to at least one example, a method is provided for sensing light. The method includes: obtaining an active state of a reset signal at a reset input node of an electrical component; in response to obtaining the active state of the reset signal, latching a voltage of an output node of the electrical component at a first voltage and latch a voltage of a cross-connected node of the electrical component at a second voltage, different from the first voltage; obtaining a photocurrent generated by a photosensitive element coupled to at least one of the cross-connected node or the output node; and in response to at least one of the cross-connected node falling below a first threshold voltage or the output node rising above a second threshold voltage, latching a third voltage at the output node, the third voltage being different from the first voltage.

In another example, an apparatus for sensing light is provided that includes at least one memory and at least one processor coupled to the at least one memory. The at least one processor is configured to: obtain an active state of a reset signal at a reset input node of an electrical component; in response to obtaining the active state of the reset signal, latch a voltage of an output node of the electrical component at a first voltage and latch a voltage of a cross-connected node of the electrical component at a second voltage, different from the first voltage; obtain a photocurrent generated by a photosensitive element coupled to at least one of the cross-connected node or the output node; and in response to at least one of the cross-connected node falling below a first threshold voltage or the output node rising above a second threshold voltage, latch a third voltage at the output node, the third voltage being different from the first voltage.

In another example, a non-transitory computer-readable medium is provided that has stored thereon instructions that, when executed by one or more processors, cause the one or more processors to: obtain an active state of a reset signal at a reset input node of an electrical component; in response to obtaining the active state of the reset signal, latch a voltage of an output node of the electrical component at a first voltage and latch a voltage of a cross-connected node of the electrical component at a second voltage, different from the first voltage; obtain a photocurrent generated by a photosensitive element coupled to at least one of the cross-connected node or the output node; and in response to at least one of the cross-connected node falling below a first threshold voltage or the output node rising above a second threshold voltage, latch a third voltage at the output node, the third voltage being different from the first voltage.

In another example, an apparatus for sensing light is provided. The apparatus includes: means for obtaining an active state of a reset signal at a reset input node of an electrical component; means for, means for latching, in response to obtaining the active state of the reset signal, a voltage of an output node of the electrical component at a first voltage and latch a voltage of a cross-connected node of the electrical component at a second voltage, different from the first voltage; means for obtaining a photocurrent generated by a photosensitive element coupled to at least one of the cross-connected node or the output node; and means for latching, in response to at least one of the cross-connected node falling below a first threshold voltage or the output node rising above a second threshold voltage, a third voltage at the output node, the third voltage being different from the first voltage.

In some aspects, one or more of the apparatuses described herein is, is a part of, or includes a mobile device (e.g., a mobile telephone or so-called “smart phone”, a tablet computer, or other type of mobile device), a wearable device, an extended reality device (e.g., a virtual reality (VR) device, an augmented reality (AR) device, or a mixed reality (MR) device), a personal computer, a laptop computer, a video server, a television (e.g., a network-connected television), a vehicle (or a computing device or system of a vehicle), or other device. In some aspects, the apparatus includes at least one camera for capturing one or more images or video frames. For example, the apparatus can include a camera (e.g., an RGB camera) or multiple cameras for capturing one or more images and/or one or more videos including video frames. In some aspects, the apparatus includes a display for displaying one or more images, videos, notifications, or other displayable data. In some aspects, the apparatus includes a transmitter configured to transmit one or more video frame and/or syntax data over a transmission medium to at least one device. In some aspects, the processor includes a neural processing unit (NPU), a central processing unit (CPU), a graphics processing unit (GPU), or other processing device or component.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating side channel attacks on security information assets in a computing device, in accordance with some examples of the present disclosure;

FIG. 2 is a block diagram illustrating example laser fault injection (LFI) attack on an integrated circuit (IC) chip, in accordance with some examples of the present disclosure;

FIG. 3 is a diagram illustrating a photocurrent generation mechanism in an LFI attack, in accordance with some examples of the present disclosure;

FIG. 4 is a block diagram illustrating an example computing system including an LFI sensing array, in accordance with some examples of the present disclosure;

FIG. 5A is a schematic diagram illustrating an example latch that can be included in a computing device, in accordance with some examples of the present disclosure;

FIG. 5B illustrates the example latch of FIG. 5A implemented with N-channel metal-oxide semiconductor (NMOS) transistors and P-channel metal-oxide semiconductor (PMOS) transistors, in accordance with some examples of the present disclosure;

FIG. 6A is a schematic diagram illustrating an example LFI sensing circuit, in accordance with some examples of the present disclosure;

FIG. 6B illustrates the example LFI sensing circuit of FIG. 6A implemented with NMOS transistors and PMOS transistors, in accordance with some examples of the present disclosure;

FIG. 7 is a block diagram illustrating an example array configuration for connecting LFI sensing circuits, in accordance with some examples of the present disclosure;

FIG. 8 is a flow diagram illustrating example of a process for sensing light, in accordance with some examples of the present disclosure;

FIG. 9 is a diagram illustrating an example of a computing system, in accordance with some examples of the present disclosure.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the application as set forth in the appended claims.

Computing devices often employ various techniques to protect data. As an example, data may be subjected to encryption and decryption techniques in a variety of scenarios, such as writing data to a storage device, reading data from a storage device, writing data to or reading data from a memory device, encrypting and decrypting blocks and/or volumes of data, encrypting and decrypting digital content, performing inline cryptographic operations, etc. Such encryption and decryption operations are often performed, at least in part, using a security information asset, such as a cryptographic key, a derived cryptographic key, etc.

Certain scenarios exist in which attacks are performed in an attempt to obtain such security information assets. For example, an attacker can attempt to reveal a security information asset and/or bypass a security check using a laser fault injection (LFI) side channel attack. In some implementations, circuitry can be included to detect an attempted LFI side channel attack. In some implementations, specialized circuitry can indirectly detect an LFI attack (e.g., by detecting a change in a substrate bulk voltage). In some cases, the specialized circuitry may require one or more analog components to perform a voltage comparison. Systems and techniques described herein provide for direct detection of light using a LFI sensing circuit. In some aspects, the LFI circuit can include a latch and one or more photosensitive elements. In some implementations, the LFI circuit can be implemented with digital circuitry that can be implemented inside and/or outside of a security perimeter of a computing device.

A security information asset may be a cryptographic key used for encrypting and/or decrypting data used by a computing device. Such a security information asset may be stored in secure information storage. In one illustrative example, security information assets can include private keys (also referred to herein as secret keys) of a symmetric cryptographic cypher and/or private keys of an asymmetric cryptographic cypher. In some cases, the secure information storage can include a security information asset storage device. In some examples, the security information asset storage device is a read only storage device, such as a read-only memory device, a one-time programmable (OTP) storage device, etc. In some examples, the security information asset storage device is a re-programmable storage device such as a non-volatile memory device, a flash storage device, etc. In some examples, a security information asset may be obtained one time from the information asset storage device once per boot or reboot of a computing device.

Security information assets may be obtained from the security information asset storage device during execution of a computing device (e.g., at boot, reboot and/or during updates), stored in a separate storage device, and provided as needed to security components (e.g., cryptographic engines, key tables, key derivation functions, etc.) for performing security operations (e.g., encryption and/or decryption of data). Security information assets so obtained may be directly used by any number of security components and/or may be used for deriving additional security information assets (e.g., derived keys used by cryptographic engines for encrypting and/or decrypting data), which is an example of a security operation. In some cases, security operations can include other steps or transformations using security information assets without departing from the scope of the present disclosure.

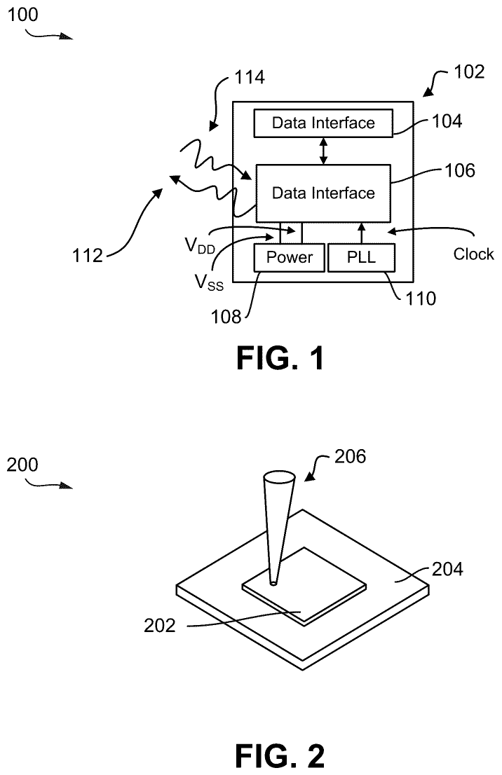

In some cases, security information assets can be compromised by side channel attacks. FIG. 1 is a block diagram 100 illustrating side channel attacks on security information assets in a computing device (e.g., cryptographic device 102). In some examples, cryptographic device 102 may obtain a security information asset (e.g., a cryptographic key). For example, the security information asset may be obtained from a security information asset storage when a computing device boots, reboots, and/or updates to be used for various security operations (e.g., encryption and/or decryption operations, key derivation operations, other steps or transformations performed using a security information asset, etc.). In some cases, the security information asset may be stored on the security information asset storage in a masked form or an unmasked form. In some cases, the cryptographic device 102 can communicate with the secure information asset storage over a data interface 104.

In some examples, a secure execution environment is any portion of a computing device that is a secure area of the computing device. Examples of secure execution environments include, but are not limited to, trusted management environments, trusted execution environments, trust zones, trusted platform modules, secure components, secure elements, and/or any combination thereof.

In some aspects, security components of a computing device may require a security information asset (e.g., a secret key) to perform one or more security operations (e.g., encrypting and/or decrypting data, generating derivative cryptographic keys, any other steps and or transformations performed using a security information asset, etc.). For example, the security components can include the cryptographic processor 106 of FIG. 1. As illustrated, the data interface 104 can be communicatively coupled to the cryptographic processor 106 and data can be exchanged between data interface 104 and cryptographic processor 106. For example, the exchanged data can include, without limitation, plain text, cypher text, secret keys, security information assets, and/or any combination thereof. As illustrated in FIG. 1, the cryptographic device 102 can include power components 108 that can generate reference voltages (e.g., V_{DD}, V_{SS}) for powering the cryptographic processor 106. In some examples, the cryptographic device 102 can include a phase locked loop (PLL) 110 for providing a clock signal to the cryptographic processor 106.

In some cases, use of security information assets may allow an attacker to use various techniques to obtain all or any portion of a security information asset, which may potentially compromise the security of a computing device. As an example, an attacker may perform a side channel attack by using a measurement device (e.g., an oscilloscope) to measure any number of characteristics of a computing device as it operates (e.g., voltages, power, electromagnetic outputs, timing information, sound, temperature, etc.). In some cases, side channel attacks that include measurements of emitted signals from the 102 can be referred to as a passive attack 112. n some cases, an attacker can utilize a machine learning (ML) model (e.g., a deep learning neural network) to aid in a side channel attack. In some examples, an attacker may utilize an active attack 114 for performing a side channel attack. For example, an attacker may employ fault injection techniques. In one illustrative example, a laser fault injection (LFI) can be utilized in a side channel attack on the cryptographic device 102.

In some cases, an attacker using a side channel attack or a fault injection attack as a cryptographic key is being transmitted and/or received (e.g., when obtained from a security information asset storage device at boot time, when obtained from a different storage device, when provided to security components for use in performing security operations, used to derive other cryptographic keys, etc.) may be able to deduce the cryptographic key, and thus be able to use the key to decrypt data on the computing device and/or encrypt potentially malicious data using the correct key, which may then be used by the computing device. In some cases, an attacker using a side channel attack can induce a single event upset (SEU) such as a bit-flip. In some cases, a side channel attack can be used to reveal a secret key, corrupt code execution within the cryptographic device 102, bypass secure boot, and/or any combination thereof.

FIG. 2 illustrates an example diagram of an LFI attack 200 on an integrated circuit chip 202. In the illustrated example of FIG. 2, the integrated circuit chip 202 is attached to a printed circuit board 204. In some cases, the integrated circuit chip 202 can include a cryptographic device 102 as illustrated in FIG. 1. As illustrated in FIG. 2, a laser 206 can be focused on a small area of the integrated circuit chip 202. For example, the laser 206 may be focused on a portion of the integrated circuit chip 202 that includes the cryptographic device 102 of FIG. 1.

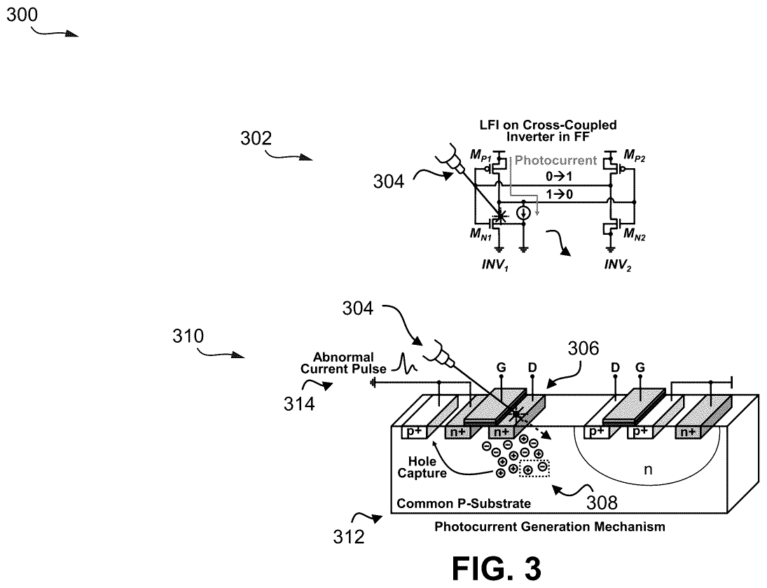

Referring to FIG. 3, an example LFI attack 300 illustrates a photocurrent generation mechanism in a silicon integrated circuit. As illustrated in FIG. 3, a circuit diagram 302 illustrates a cross-coupled inverter circuit included in a flip-flip (FF). FIG. 3 also depicts a simplified cross-sectional view 310 of a silicon substrate 312 corresponding to the N-channel metal-oxide semiconductor (NMOS) transistor M_{N1} and the P-channel metal-oxide semiconductor (PMOS) transistor M_{P1} of one inverter of the FF shown in circuit diagram 302. For example, the FF illustrated in circuit diagram 302 may be a FF included in the cryptographic processor 106 of FIG. 1. Although the example silicon substrate 312 is illustrated using a common P-type substrate, it should be understood that the systems and techniques described herein can be implemented with other semiconductor technologies without departing from the scope of the present disclosure. For example, without limitation, N-type substrates, Silicon Germaniun (SiGe) substrates, any other semiconductor technology, and/or any combination thereof.

In the illustrated example, a laser 304 is depicted as illuminating the drain 306 of an N-channel metal-oxide semiconductor (NMOS) transistor M_{N1} in both the circuit diagram 302 and the simplified cross-sectional view 310. In the illustrated example, the laser 304 induces the generation 308 of electronic-hole pairs in a silicon substrate 312. As illustrated in FIG. 3, the generation of electron-hole pairs can result in an abnormal current pulse 314. In some cases, the abnormal current pulse 314 can in turn result in a SEU and/or other fault in the operation of the FF. In some cases, special LFI detection monitoring is needed to detect that an LFI attack has occurred.

In some examples, changes in the substrate potential induced by the LFI can be detected by monitoring the substrate potential with on-chip monitoring at distributed substrate potential measurement sensors distributed throughout the substrate of a cryptographic device (e.g., cryptographic device 102 of FIG. 1). In some cases, the substrate potential measurement sensing technique can be referred to as a substrate potential bounce (SPB) monitor. In some cases, the addition of substrate potential measurement sensors throughout a cryptographic device can be costly due to area consumed by measurement pads and/or specialized measurement circuitry. For example, a SPB monitor may utilize specialized measurement circuitry including analog buffers and/or voltage comparators to detect the SPB. In some cases, the specialized measurement circuitry may require trimming and/or threshold level tuning to properly detect an LFI attack. In some aspects, an SPB monitor may provide only an indirect measurement of an LFI by measuring then effect of the LFI on the power distribution networks (e.g., electrical traces for distributing V_{DD}, V_{SS}) of a cryptographic device. In some cases, a SPB monitor may also be susceptible to latch-up issues that may require cycling the power supply of the cryptographic device off and back on to resolve.

In some implementations, a bulk built-in current sensor (BBICS) can be used to detect changes in substrate potential resulting from an LFI attack on a cryptographic device (e.g., cryptographic device 102 of FIG. 1). In some cases, the BBICS sensor can be implemented by providing an isolated bulk terminal and back-end circuitry to detect bulk voltage spikes that can result from abnormal current pulses (e.g., abnormal current pulse 314 of FIG. 3). In some cases, a dedicated bulk voltage distribution network with a lower resistance may be used to distribute the bulk voltage throughout a cryptographic device. In some examples, the positive and negative voltage rails (e.g., V_{DD}, V_{SS}) may each also have a dedicated voltage distribution network with a low resistance. In some cases, adding the dedicated bulk voltage distribution network can add cost and/or complexity to the design of a cryptographic device.

Accordingly, systems and techniques are needed for detecting an attempted LFI side channel attack with high accuracy, low cost, low area consumption and low susceptibility to latch-up issues.

Systems and techniques are described herein for providing a latch-based LFI sensor array. The systems and techniques described herein can improve accuracy of LFI attack detection by mimicking the exact fault mechanism caused by an LFI attack in a latch rather than an indirect measurement of the bulk voltage. In addition, the systems and techniques described herein can be area efficient due to lack of requirement for analog circuitry and/or back-end measurement sensors to detect a fault caused by LFI. In some cases, the systems and techniques can be implemented without specialized analog measurement circuitry to avoid the need for trimming and/or threshold level tuning. In some aspects, the area and/or cost for implementing the systems and techniques described herein can remain low by implementing a latch-based LFI sensor array using a custom standard cell. In some implementations, the custom standard cell can be integrated within the layout of other standard cells such as flip-flops in a standard cell library. In some aspects, by utilizing a standard cell approach, the performance of the LFI side channel detection systems and techniques can be ratio-metric to the performance of other components of a cryptographic device over process variations, voltage fluctuations, and/or temperature changes.

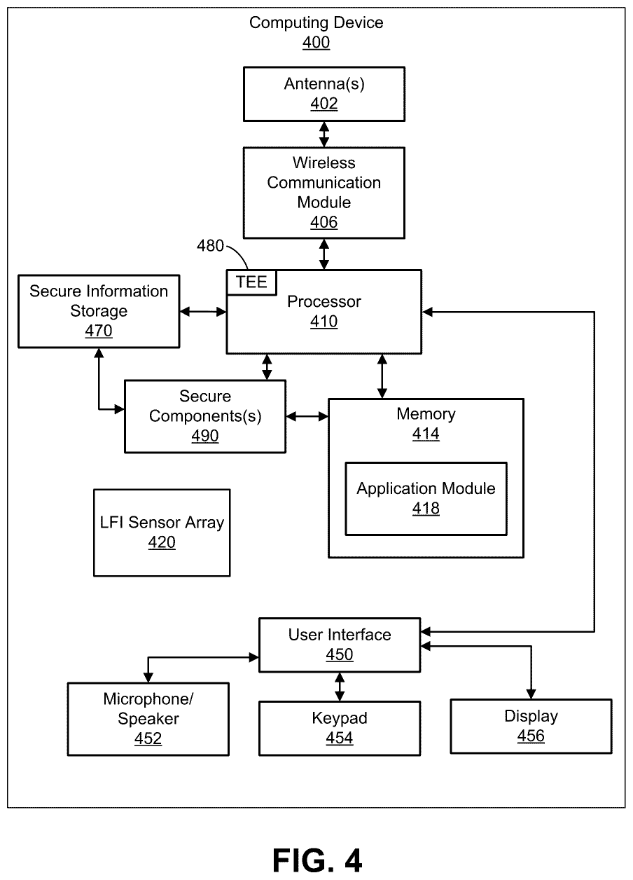

Various aspects of the systems and techniques described herein will be discussed below with respect to the figures. According to various examples, FIG. 4 is a diagram illustrating an example computing device 400. The computing device 400 may include, but is not limited to, any of the following: one or more processors (e.g., components that include integrated circuitry, memory, input and output device(s) (not shown), non-volatile storage hardware, one or more physical interfaces, any number of other hardware components (not shown), and/or any combination thereof. Examples of computing devices include, but are not limited to, a mobile device (e.g., laptop computer, smart phone, personal digital assistant, tablet computer, automobile computing system, and/or any other mobile computing device), an Internet of Things (IoT) device, a server (e.g., a blade-server in a blade-server chassis, a rack server in a rack, etc.), a desktop computer, a storage device (e.g., a disk drive array, a fibre channel storage device, an Internet Small Computer Systems Interface (iSCSI) storage device, a tape storage device, a flash storage array, a network attached storage device, etc.), a network device (e.g., switch, router, multi-layer switch, etc.), a wearable device (e.g., a network-connected watch or smartwatch, or other wearable device), a robotic device, a smart television, a smart appliance, an extended reality (XR) device (e.g., augmented reality (AR), virtual reality (VR), etc.), any device that includes one or more SoCs, and/or any other type of computing device with the aforementioned requirements. In one or more examples, any or all of the aforementioned examples may be combined to create a system of such devices, which may collectively be referred to as a computing device. Other types of computing devices may be used without departing from the scope of examples described herein.

As illustrated, the computing device 400 may include one or more antennas 402, one or more wireless communication modules 406, a processor 410, memory 414, application module 418, LFI sensor array 420, user interface 450, microphone/speaker 452, keypad 454, display 456, secure information storage 470, trusted execution environment 480, and secure components 490.

As shown, the computing device 400 may include one or more wireless communication modules 406 that may be connected to one or more antennas 402. The one or more wireless communication modules 406 comprise suitable devices, circuits, hardware, and/or software for communicating with and/or detecting signals to/from an access point, a network, a base station, and/or directly with other wireless devices within a network.

In some implementations, the one or more wireless communication modules 406 may comprise a CDMA communication system suitable for communicating with a CDMA network of wireless base stations. In some implementations, the wireless communication system may comprise other types of cellular telephony networks, such as, for example, TDMA, GSM, WCDMA, LTE, NR, and the like. Additionally, any other type of wireless networking technologies may be used, including, for example, WiMax (802.16), Wi-Fi (802.11), and the like.

The processor(s) (also referred to as a controller) 410 may be connected to the one or more wireless communication modules 406. The processor 410 may include one or more microprocessors, microcontrollers, and/or digital signal processors that provide processing functions, as well as other calculation and control functionality. The processor 410 may be coupled to storage media (e.g., memory) 414 for storing data and software instructions for executing programmed functionality within the mobile device. The memory 414 may be on-board the processor 410 (e.g., within the same IC package), and/or the memory may be external memory to the processor and functionally coupled over a data bus.

A number of software engines and data tables may reside in memory 414 and may be utilized by the processor 410 in order to manage communications, perform positioning determination functionality, and/or perform device control functionality. In some cases, the memory 414 may include an application module 418. It is to be noted that the functionality of the modules and/or data structures may be combined, separated, and/or be structured in different ways depending upon the implementation of the computing device 400.

The application module 418 may include a process running on the processor 410 of the computing device 400, which may request data from one of the other modules of the computing device 400. Applications typically run within an upper layer of the software architectures and may be implemented in a rich execution environment of the computing device 400, and may include indoor navigation applications, shopping applications, financial services applications, social media applications, location aware service applications, etc.

As illustrated, the computing device 400 can include an LFI sensor array 420. In some cases, the LFI sensor array 420 can be incorporated with one or more of the processor 410, secure information storage 470, trusted execution environment 480, or secure components 490. In some cases, the LFI sensor array 420 can include custom sensing latches configured to be more sensitive to light that standard latches and/or FFs included in the computing device 400. In some cases, by making the custom sensing latches more sensitive to light than the standard latches and/or FFs, the LFI attack can trigger the custom sensing latches before a fault occurs in the standard latches. In some aspects, by detecting the LFI before any of the standard latches and/or FFs are affected by the LFI, defensive measures can be implemented before any faults occur.

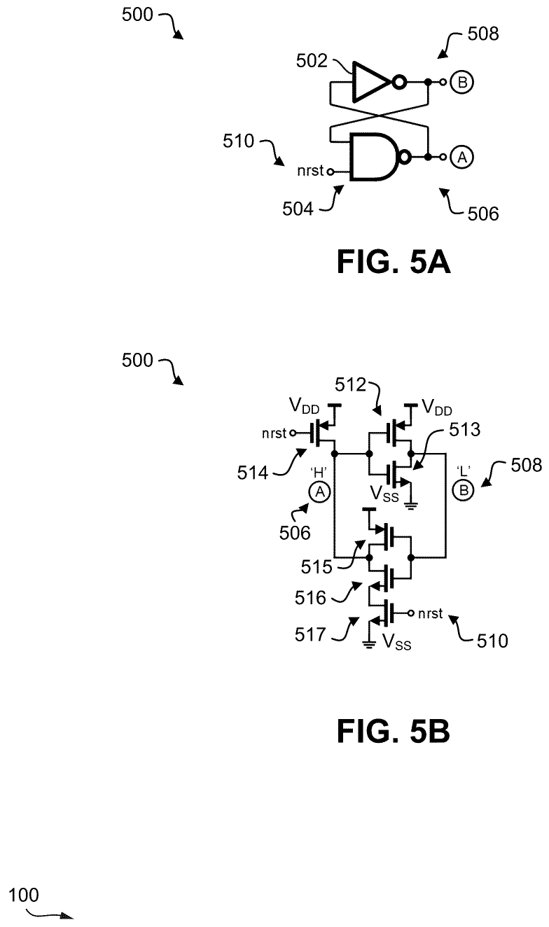

FIG. 5A and FIG. 5B illustrate an example of a standard latch 500 that can be included in computing device 400 of FIG. 4. FIG. 5A illustrates a schematic representation of the standard latch 500. FIG. 5B illustrates the standard latch 500 implemented with NMOS transistors and PMOS transistors. As illustrated in FIG. 5A, the standard latch 500 can be implemented with a cross-connected inverter 502 and NAND gate 504.

As used herein, “cross-connected” logic gates refer to a first logic gate and second logic gate where an output of the first logic gate is an input to the second logic gate and an output of the second logic gate is an input to the first logic gate. In a cross-connected configuration, one or more of the output of the first logic gate or the output of the second logic gate can be used as an output for the cross-connected logic gates (e.g., a latched output).

In the illustrated example of FIG. 5A, the circuit node at the output of the NAND gate 504 is only used for cross-connecting the output of the NAND gate 504 to the input of the inverter 502. Accordingly, the node A at the output of the NAND gate 504 is referred to as cross-connected node A 506. As illustrated, the circuit node at the output of the inverter 502 provides cross-connection between the output of the inverter 502 and an input of the NAND gate 504 and can be an output node for the latch 500. Accordingly, node B at the output of the inverter 502 is referred to as output node B 508. As illustrated, a cross-connected node A 506 can be an input to the inverter 502 and is output by the NAND gate 504. As illustrated, an output node B 508 can be a first input to the NAND gate 504 and is output by the inverter 502. In some cases, an active low reset signal nrst 510 can be a second input to the NAND gate 504.

Referring to FIG. 5B, an example implementation of the standard latch 500 with NMOS and PMOS transistors is shown. For example, FIG. 5B illustrates the inverter 502 of FIG. 5A implemented by a PMOS transistor 512 and NMOS transistor 513. In the illustrated example, the gates of the PMOS transistor 512 and NMOS transistor 513 are coupled to the cross-connected node A 506 and the drains of the PMOS transistor 512 and NMOS transistor 513 are coupled to the output node B 508. As illustrated in FIG. 5B, the NAND gate 504 is implemented by PMOS reset transistor 514 in parallel with PMOS transistor 515 in a pull-up configuration and NMOS transistor 516 in series with NMOS reset transistor 517 in a pull-down configuration. As illustrated, the gates of the PMOS reset transistor 514 and the NMOS reset transistor 517 are coupled to active low reset signal nrst 510.

As used herein, NMOS transistors in a pull-down configuration may hereinafter be referred to as “pull-down NMOS transistors.” As used herein, PMOS transistors in a pull-up configuration may hereinafter be referred to as “pull-up PMOS transistors.” As used herein, the PMOS reset transistor 514 and the NMOS reset transistor 517 are hereinafter collectively referred to as a “reset circuit.” As used herein, a circuit node coupled to an input (e.g., a gate) of the PMOS reset transistor 514 and an input (e.g., a gate) of the NMOS reset transistor 517 is hereinafter referred to as a “reset input node.” As used herein, a circuit node coupled to an output (e.g., a drain) of the PMOS reset transistor 514 and an input output (e.g., a drain) of the NMOS reset transistor 517 is referred to as a “reset output node.”

In the illustration of FIG. 5B, negative and positive voltage rails are indicated by V_{SS} and V_{DD}, respectively. As used herein, a pull-up configuration refers to a circuit configuration that, when activated by an appropriate input voltage (e.g., V_{SS}) at the circuit input (e.g., at a transistor gate) drives the output of the circuit configuration to the positive voltage rail V_{DD}. A pull-down configuration refers to a circuit configuration that, when activated by an appropriate input voltage (e.g., V_{DD}) at the circuit input (e.g., at a transistor gate) drives the output of the circuit configuration to the negative voltage rail V_{SS}.

As illustrated in FIG. 5A and FIG. 5B, when the active low reset signal nrst 510 is activated (e.g., driven with a low voltage), the standard latch 500 can latch the output node B 508 to a low voltage L and the cross-connected node A 506 to a high voltage H. In the absence of any other input signal to the standard latch 500, the voltages at cross-connected node A 506 and output node B 508 should remain latched as long as the standard latch 500 continues to receive power. However, in the case of an LFI attack, photocurrent generated in the substrate of the standard latch 500 (e.g., silicon substrate 312 of FIG. 3) may result in a bit-flip of the standard latch 500. For example, an LFI attack may cause the standard latch 500 latch the output node B 508 to a high voltage H and the cross-connected node A 506 to a low voltage L.

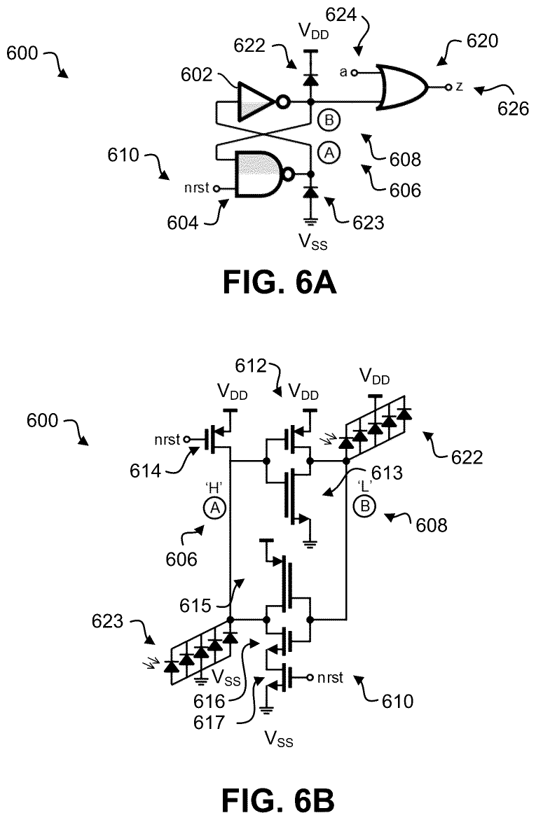

FIG. 6A and FIG. 6B illustrate an example of an LFI sensing circuit 600 that can be included in an LFI sensor array (e.g., LFI sensor array 420). In some cases, the LFI sensing circuit 600 implemented as a modified version of the standard latch 500 of FIG. 5A and FIG. 5B. In some cases, the standard latch 500 and/or the LFI sensing circuit 600 can be included in a standard cell library of logic gates used in generating an integrated circuit layout of a computing device. FIG. 6A illustrates a schematic representation of the LFI sensing circuit 600. FIG. 6B illustrates the LFI sensing circuit 600 implemented with NMOS transistors, PMOS transistors and diodes.

As illustrated in FIG. 6A, the LFI sensing circuit 600 can be implemented with a cross-connected weak pull-down inverter 602 and weak pull-up NAND gate 604. As illustrated, a cross-connected node A 606 is an input to the weak pull-down inverter 602 and is output by the weak pull-up NAND gate 604. As illustrated, an output node B 608 is a first input to the weak pull-up NAND gate 604 and is output by the weak pull-down inverter 602. In some cases, an active low reset signal nrst 610 can be a second input to the weak pull-up NAND gate 604. As should be understood by comparison of the schematic representations of the standard latch 500 and the LFI sensing circuit 600, the two latches can perform logically identical functions. For example, when the active low reset signal nrst 610 is activated (e.g., driven with a low voltage), the LFI sensing circuit 600 can latch the output node B 608 to a low voltage L and the cross-connected node A 606 to a high voltage H. In some implementations, the low voltage L can represent a logical false state and the high voltage H can represent a logical true state. In the illustration of FIG. 6A, negative and positive voltage rails are indicated by V_{SS} and V_{DD}, respectively.

As illustrated in FIG. 6A, the output node B 608 can be coupled to a fault detection input of an OR gate 620. In some cases, a fault detection feed-through input 624 of the OR gate 620 can be coupled to the fault detection output 626 of a different LFI sensing circuit 600 to allow for chaining of multiple LFI sensing circuits 600. If either the output node B 608 or the fault detection feed-through input 624 are active (e.g., a logical true state), the output of the OR gate 620 can become active.

In some examples, the output node B 608 can be coupled to the anode(s) of one or more photosensitive elements 622. As illustrated, the cathode(s) of the one or more photosensitive elements 622 can be coupled to the positive voltage rail V_{DD}. In some cases, the cross-connected node A 606 can be coupled to the cathode(s) of one or more photosensitive elements 623. As illustrated, the anode(s) of the one or more photosensitive elements 623 can be coupled to the negative voltage rail V_{SS}. In some implementations, the one or more photosensitive elements 622 can be implemented as PMOS diodes, NMOS diodes, PN junctions, photopixels, or any other suitable photosensitive elements.

In some cases, when light shines on the one or more photosensitive elements 623, a photocurrent can be generated (e.g., as illustrated by the photocurrent generation mechanism of FIG. 3). In some cases, the photocurrent generated in the one or more photosensitive elements 623 may begin to pull down the voltage of cross-connected node A 606 below the high voltage H. In some cases, if the voltage of cross-connected node A 606 becomes sufficiently low due to the amount of light (and corresponding photocurrent), the output of the weak pull-down inverter 602 may flip to a high voltage H. In some aspects, as the voltage on the output node B 608 rises above a threshold voltage level, the weak pull-up NAND gate 604 can drive the cross-connected node A 606 down to a low voltage (e.g., low voltage L). In some cases, the LFI sensing circuit 600 can become latched with the output node B 608 at the high voltage H, which can in turn cause a fault detection output 626 of the OR gate 620 to become active (e.g., a logical true state).

In some implementations, the low voltage L at the gate of the weak PMOS transistor 615 from the output node B 608 can cause the weak PMOS transistor 615 to fight against the pulldown current through the one or more photosensitive elements 623. In some cases, the pull-up strength of the weak PMOS transistor 615 can be deliberately weakened (e.g., relative to the pull-up strength of PMOS transistor 614, PMOS transistor 612) to reduce the amount of photocurrent required to pull down the cross-connected node A 606 and flip the output of the weak pull-down inverter 602 to the high voltage H. In one illustrative example, the length L of the weak PMOS transistor 615 can be increased relative to the lengths of the PMOS transistor 612 and PMOS transistor 614 while the width W of the weak PMOS transistor 615 can remain consistent with the widths of PMOS transistor 612 and PMOS transistor 614 to provide a relatively low pull-up strength for the weak PMOS transistor 615.

In some cases, when light shines on the one or more photosensitive elements 622, a photocurrent can be generated (e.g., as illustrated by the photocurrent generation mechanism of FIG. 3). In some cases, the photocurrent generated in the one or more photosensitive elements 622 may begin to pull-up the voltage of output node B 608 above the low voltage L. In some cases, if the voltage of output node B 608 becomes sufficiently high due to the amount of light (and corresponding photocurrent), the output of the weak pull-up NAND gate 604 may flip to a low voltage L. In some aspects, once the voltage on the cross-connected node A 606 falls below a threshold voltage, the weak pull-down inverter 602 can drive the output node B 608 up to a high voltage (e.g., high voltage H). In some cases, the LFI sensing circuit 600 can become latched with the output node B 608 at the high voltage H, which can in turn cause a fault detection output 626 of the OR gate 620 to become active (e.g., a logical true state).

In some implementations, the high voltage H at the gate of the weak NMOS transistor 613 from the cross-connected node A 606 can cause the weak NMOS transistor 613 to fight against the pull-up current through the one or more photosensitive elements 622. In some cases, the pull-down strength of the weak NMOS transistor 613 can be deliberately weakened (e.g., relative to the pull-down strength of NMOS transistor 616, NMOS transistor 617) to reduce the amount of photocurrent required to pull-up the output node B 608 and flip the output of the weak pull-up NAND gate 604 to the low voltage L. In one illustrative example, the length L of the weak NMOS transistor 613 can be increased relative to the lengths of the NMOS transistor 616 and NMOS transistor 617 while the width W of the weak NMOS transistor 613 can remain consistent with the widths of the NMOS transistor 616 and NMOS transistor 617 to provide a relatively low pull-down strength for the weak NMOS transistor 613.

In some cases, when light is simultaneously incident on the one or more photosensitive elements 622 and the one or more photosensitive elements 623, the effects of the resulting pull-up photocurrent through the one or more photosensitive elements 622 and the pull-down photocurrent through the one or more photosensitive elements 623 can combine. As described above, the photocurrents both tend to flip the voltage states of the cross-connected node A 606 and output node B 608 and the cumulative effect of both a pull-up photocurrent and a pull-down photocurrent can serve to increase the sensitivity of the LFI sensing circuit 600 to detecting a fault from an LFI attack.

FIG. 6B illustrates an implementation of the LFI sensing circuit 600 using NMOS transistors and PMOS transistors. As illustrated in FIG. 6B, the weak pull-down inverter 602 can be implemented by a PMOS transistor 612 and weak NMOS transistor 613. In the illustrated example, the gates of the PMOS transistor 612 and weak NMOS transistor 613 are coupled to the cross-connected node A 606 and the drains of the PMOS transistor 612 and weak NMOS transistor 613 are coupled to the output node B 608. As illustrated in FIG. 6B, the weak pull-up NAND gate 604 is implemented by PMOS transistor 614 in parallel with weak PMOS transistor 615 in a pull-up configuration and NMOS transistor 616 in series with NMOS transistor 617 in a pull-down configuration. As illustrated in FIG. 6B, the gates of the PMOS transistor 614 and the NMOS transistor 617 are coupled to active low reset signal nrst 610. In the illustration of FIG. 6B, negative and positive voltage rails are indicated by V_{SS} and V_{DD}, respectively.

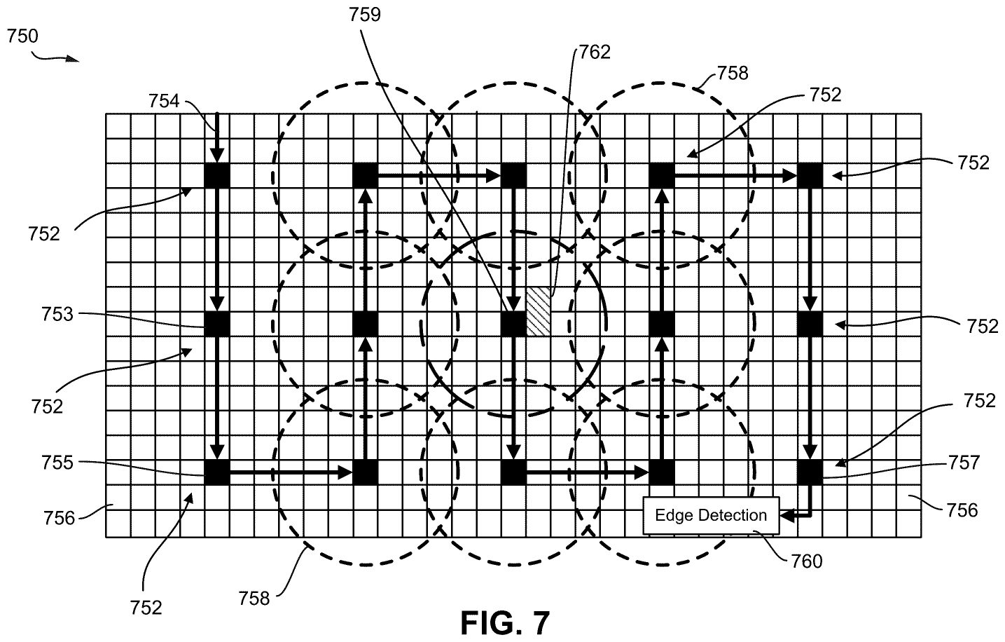

FIG. 7 is a diagram illustrating an example array configuration 750 for connecting LFI sensing circuits 752 (e.g., LFI sensing circuit 600 of FIG. 6A and FIG. 6B) to an edge detection module 760. In the illustrated example of FIG. 7, routing traces 754 interconnect LFI sensing circuits 752 that are distributed in a rectangular array of logic cells 756. For example, the logic cells 756 can be included in cryptographic processor 106 of FIG. 1, processor 410, trusted execution environment 480, secure components 490 of FIG. 4, and/or any combination thereof. In one illustrative example, a logic cell 756 can include standard latch 500 of FIG. 5A. As illustrated in FIG. 7, each of the LFI sensing circuits 752 can have a corresponding sensing area 758. For the purposes of visual clarity, the sensing areas 758 are illustrated for a 3×3 grid of LFI sensing circuits 752. It should be understood that each LFI sensing circuit 752 can have a corresponding sensing area 758. For example, FIG. 7 illustrates a laser location 762 that may correspond to the position of a laser during an LFI attack. As illustrated, the laser location 762 covers two adjacent logic cells 756 within a sensing area 758 of the LFI sensing circuit 759. In some cases, if enough light is collected from the laser location 762 a fault detection output signal (e.g., from fault detection output 626 of FIG. 6A) of the LFI sensing circuit 759 may become active (e.g., set to a logical true state). As illustrated in FIG. 7, the sensing areas 758 can be configured to overlap to provide coverage of all of the logic cells 756 within the array configuration 750. In some cases, LFI sensing circuits 752 may be positioned within a security perimeter that corresponds to logic cells 756 utilized for cryptographic operations. In some examples, the LFI sensing circuits 752 can be arranged in a rectangular array of LFI sensing circuits 752. In some implementations, LFI sensing circuits 752 may be positioned both inside and outside of the security perimeter to prevent an attacker from using the locations of LFI sensing circuits 752 to identify the locations of logic cells 756 utilized for cryptographic operations.

In the illustrated example of FIG. 7, the LFI sensing circuits 752 are arranged in a rectangular lattice at periodic intervals within the array of logic cells 756. It should be understood that other configurations of the LFI sensing circuits 752 can be used without departing from the scope of the present disclosure.

In one illustrative example, the routing traces 754 can form connections between a fault detection output of a first LFI sensing circuit 753 to a fault detection feed-through input (e.g., fault detection feed-through input 624 of FIG. 6A) of a second LFI sensing circuit 755. As illustrated in FIG. 7, the fault detection output of each of the LFI sensing circuits 752 can be coupled to a fault detection feed-through input of a subsequent LFI sensing circuit 752 until the fed through signal (e.g., a fault detection feed-through signal) from each of the LFI sensing circuits 752 reaches a final LFI sensing circuit 757. Accordingly, the LFI sensing circuits 752 can be configured to form a chain. In some examples, the fault detection output of the final LFI sensing circuit 757 can be coupled to edge detection module 760. In the illustrated configuration of FIG. 7, the edge detection module 760 can determine whether the fault detection output of the final LFI sensing circuit 757 is indicative of an LFI attack at any of the LFI sensing circuits 752. In some implementations, when the edge detection module 760 determined that the fault detection output of the final LFI sensing circuit 757 is indicative of an LFI attack, the edge detection module 760 can initial defensive measures. For example, the 760 can initiate a reboot of a computing device, a power down of a computing device, any other suitable defensive measure, or any combination thereof.

Returning to FIG. 4, in some examples, the computing device 400 includes the secure information storage 470. In some examples, the secure information storage 470 can be any storage device configured to store security information assets (e.g., cryptographic keys, metadata, etc.). For instance, the secure information storage 470 is where security information assets are stored and initially obtained from when needed for use on a computing device (e.g., for encryption and/or decryption of data). In some cases, the secure information storage 470 can include a key store or a key table. Examples of secure information storage 470 include, but are not limited to, various types of read-only memory, one-time programmable memory devices (e.g., one time programmable fuses or other types of one time programmable memory devices), non-volatile memory, etc. The secure information storage 470 may be operatively connected to the trusted execution environment 480 and/or the secure components 490. Although FIG. 4 shows the computing device 400 as including a single secure information storage 470, the computing device 400 may include any number of secure information storages without departing from the scope of examples described herein.

The processor 410 may include a trusted execution environment 480. The trusted execution environment 480 may also be referred to as a trusted management environment, trust zones, trusted platform modules, or the like. The trusted execution environment 480 can be implemented as a secure area of the processor 410 that can be used to process and store sensitive data in an environment that is segregated from the rich execution environment in which the operating system and/or applications (such as those of the application module 418) may be executed. The trusted execution environment 480 can be configured to execute secure applications (also referred to as trusted applications) that provide end-to-end security for sensitive data by enforcing confidentiality, integrity, and protection of the sensitive data stored therein. The trusted execution environment 480 can be used to store encryption keys, access tokens, and other sensitive data.

The computing device 400 may include one or more secure components 490. In some cases, the secure components 490 can be referred to as trusted components, secure elements, trusted elements, or the like. The computing device 400 may include the secure components 490 in addition to or instead of the trusted execution environment 480. The secure components 490 can comprise autonomous and tamper-resistant hardware that can be used to execute secure applications and the confidential data associated with such applications. The secure components 490 can be used to store encryption keys, access tokens, and other sensitive data. The secure components 490 can comprise a Near Field Communication (NFC) tag, a Subscriber Identity Module (SIM) card, or other type of hardware device that can be used to securely store data. The secure components 490 can be integrated with the hardware of the computing device 400 in a permanent or semi-permanent fashion or may, in some implementations, be a removable component of the computing device 400 that can be used to securely store data and/or provide a secure execution environment for applications.

Examples of secure applications that may be performed by the computing device 400, processor 410, secure information storage 470, trusted execution environment 480, secure components 490, and/or any combination thereof include, but are not limited to, encrypting data, decrypting data, key derivation, performing data integrity verification, and performing authenticated encryption and decryption. In some examples, the computing device 400 and/or portions thereof can be configured to perform the various cryptographic service types by being configured to execute one or more cryptographic algorithms. As an example, to perform encryption and decryption, one or more components (e.g., secure information storage 470, trusted execution environment 480, secure components 490) of the computing device 400 may be configured to execute one or more of the Advanced Encryption Standard XOR-encrypt-XOR Tweakable Block Ciphertext Stealing (AES-XTS) algorithm, the AES-Cipher Block Chaining (AES-CBC) algorithm, the AES-Electronic Codebook (AES-EBC) algorithm, the Encrypted Salt-Sector Initialization Vector-AES-CBC (ESSIV-AES-CBC) algorithm, etc., including any variants of such algorithms (e.g., 128 bits, 192 bits, 256 bits, etc.). As another example, to perform integrity verification, one or more components of the computing device 400 may be configured to execute a hash algorithm such as, for example, the one or more members of the SHA family of hash algorithms. As another example, to perform authenticated encryption, one or more components of the computing device 400 may be configured to perform the AES-Galois/Counter Mode (GCM) algorithm. In some aspects, one or more components of the computing device 400 may be configured to execute any other cryptographic algorithms without departing from the scope of examples described herein.

The computing device 400 may further include a user interface 450 providing suitable interface systems, such as a microphone/speaker 452, a keypad 454, and/or a display 456 that allows user interaction with the computing device 400. The microphone/speaker 452 can provide for voice communication services (e.g., using the one or more wireless communication modules 406). The keypad 454 may comprise suitable buttons for user input. The display 456 may include a suitable display, such as, for example, a backlit LCD display, and may further include a touch screen display for additional user input modes.

While FIG. 4 shows a certain number of components in a particular configuration, one of ordinary skill in the art will appreciate that the computing device 400 may include more components or fewer components, and/or components arranged in any number of alternate configurations without departing from the scope of examples described herein. Additionally, although not shown in FIG. 4, one of ordinary skill in the art will appreciate that the computing device 400 may execute any amount or type of software or firmware (e.g., bootloaders, operating systems, hypervisors, virtual machines, computer applications, mobile device apps, etc.). Accordingly, examples disclosed herein should not be limited to the configuration of components shown in FIG. 4. The components shown in FIG. 4 may or may not be discrete components. In some aspects, one or more of the components can be combined into different hardware elements, implemented in software, and/or otherwise implemented using software and/or hardware. As used herein, the term device may be a discrete component or apparatus, or may not be a discrete component. In some aspects, other devices can exist within, be part of, and/or utilize the same hardware components as a device.

As noted above the LFI sensor array 420, LFI sensing circuit 600, array configuration 750, and related techniques described herein can allow for detection of LFI attacks on a computing device. For instance, using the LFI sensing circuit 600, an LFI attack can be detected utilizing a latch that can be included in a standard cell library along with other logic gates. Further, the LFI sensing circuit 600 can detect an LFI attack without the need for complex analog circuitry. In addition, the LFI sensing circuit 600 can detect an LFI attack directly from a bit flip within a latch, similar to a bit-flip that may occur in other logic gates as a result of an LFI attack.

In contrast, some existing techniques such as SPB or BBICS may require costly and complex circuitry. In addition, such techniques indirectly measure the effect of LFI attacks by detecting the effect of photocurrent generation on a bulk voltage of an integrated circuit chip.

Further, by connecting LFI sensing circuits in an array configuration 750, a single edge detection module can be used to detect an LFI attack detected by any of the LFI sensing circuits. In some cases, the LFI sensing circuits can be distributed through an array of logic gates to cover all of the logic gates collectively within the sensing areas of the LFI sensing circuits.

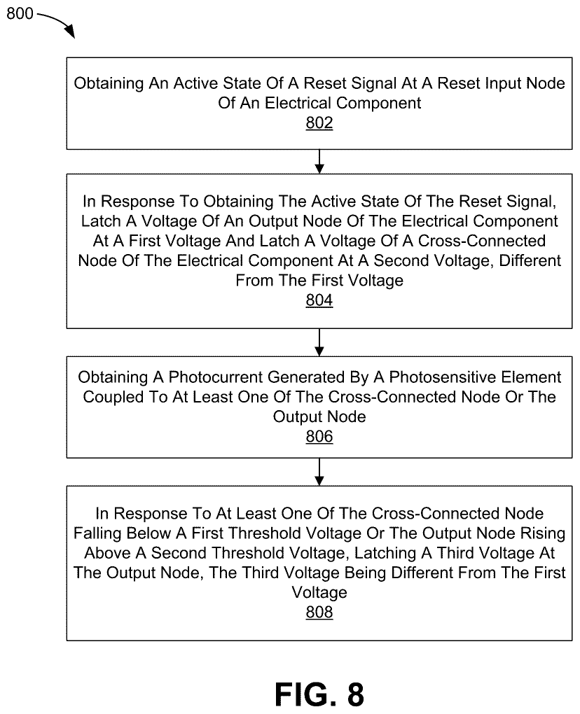

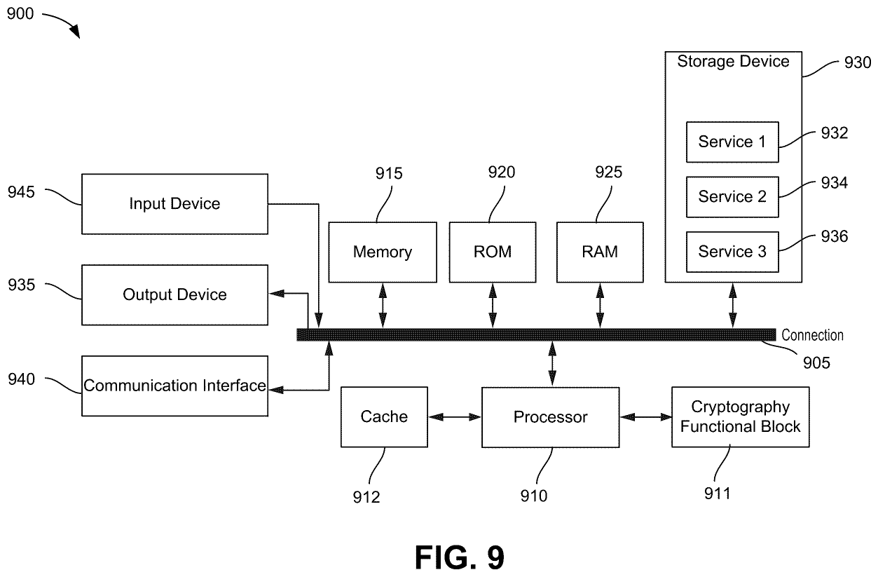

FIG. 8 is a flow diagram illustrating an example of a process 800 for sensing light. The process 800 and/or other process described herein can be performed by a computing device (or apparatus) or a component (e.g., a chipset, codec, etc.) of the computing device. The computing device may be an extended reality (XR) device (e.g., a virtual reality (VR) device or augmented reality (AR) device), a mobile device (e.g., a mobile phone), a network-connected wearable such as a watch, a vehicle or component or system of a vehicle, or other type of computing device. In one example, the process 800 and/or other process described herein can be performed by the computing device 400 of FIG. 4. In another example, one or more of the processes can be performed by the computing system 900 shown in FIG. 9. For instance, a computing device with the computing system 900 shown in FIG. 9 can include the components of the computing device 400 and can implement the operations of the process 800 of FIG. 8 and/or other process described herein. The operations of the process 800 may be implemented as software components that are executed and run on one or more processors (e.g., the processor 910 of FIG. 9, a processor such as a DSP, GPU, NPU, etc., or other processor(s)). Further, the transmission and reception of signals by the computing device in the process 800 may be enabled, for example, by one or more antennas, one or more transceivers (e.g., wireless transceiver(s)), and/or other communication components of the computing device (e.g., the communications interface 940 of FIG. 9).

At block 802, the computing device (or component thereof) can obtain an active state of a reset signal (e.g., active low reset signal nrst 610 of FIG. 6A and FIG. 6B) at a reset input node of an electrical component.

At block 804, the computing device (or component thereof) can, in response to obtaining the active state of the reset signal, latch a voltage of an output node (e.g., output node B 608 of FIG. 6A and FIG. 6B) of the electrical component at a first voltage (e.g., V_{DD}, V_{SS} of FIG. 6A and FIG. 6B) and latch a voltage of a cross-connected node (e.g., cross-connected node A 606 of FIG. 6A and FIG. 6B) of the electrical component at a second voltage, different from the first voltage.

At block 806, the computing device (or component thereof) can obtain a photocurrent generated by a photosensitive element (e.g., one or more photosensitive elements 622, 623 of FIG. 6B) coupled to at least one of the cross-connected node or the output node. In some cases, the photosensitive element includes one or more of NMOS diodes, PMOS diodes, PN junctions, or photopixels.

At block 808, the computing device (or component thereof) can, in response to at least one of the cross-connected node falling below a first threshold voltage or the output node rising above a second threshold voltage, latch a third voltage at the output node, the third voltage being different from the first voltage. In some examples, the defensive measure includes one or more of rebooting or powering down the computing device.

In some implementations, the computing device (or component thereof) can output a fault detection output signal (e.g., by fault detection output 626 of FIG. 6A). In some cases, the fault detection output signal is based on a combination of a voltage of the output node and a fault detection feed-through signal (e.g., from fault detection feed-through input 624 of FIG. 6A).

In some examples, the computing device (or component thereof) can detect, by an edge detection module (e.g., edge detection module 760 of FIG. 7), a rising voltage of the output node. In some aspects, the computing device (or component thereof) can, based on detecting the rising voltage of the output node, initiating a defensive measure for a computing device.

In some examples, the processes described herein (e.g., process 800 and/or any other process described herein) may be performed by a computing device or apparatus (e.g., a computing device 400 of FIG. 4). In another example, the process 800 may be performed by a computing device with the computing system 900 shown in FIG. 9.

FIG. 9 is a diagram illustrating an example of a computing system for implementing certain aspects of the present technology. In particular, FIG. 9 illustrates an example of computing system 900, which may be for example any computing device making up internal computing system, a remote computing system, a camera, or any component thereof in which the components of the system are in communication with each other using connection 905. Connection 905 may be a physical connection using a bus, or a direct connection into processor 910, such as in a chipset architecture. Connection 905 may also be a virtual connection, networked connection, or logical connection.

In some embodiments, computing system 900 is a distributed system in which the functions described in this disclosure may be distributed within a datacenter, multiple data centers, a peer network, etc. In some embodiments, one or more of the described system components represents many such components each performing some or all of the function for which the component is described. In some embodiments, the components may be physical or virtual devices.

Example computing system 900 includes at least one processing unit (CPU or processor) 910 and connection 905 that communicatively couples various system components including system memory 915, such as read-only memory (ROM) 920 and random access memory (RAM) 925 to processor 910. computing system 900 may include a cache 912 of high-speed memory connected directly with, in close proximity to, or integrated as part of processor 910. The example computing system 900 also includes one or more cryptographical functional blocks 911 connected to the processor 910. For example, the one or more cryptographical functional blocks 911 can include cryptographical blocks for performing, without limitation, NTT computations, matrix vector multiplication (A*y), r and r.G multiplication (e.g., elliptic curve point multiplication) events (e.g., for an elliptic curve digital signature algorithm (ECDSA)), security hash algorithms, (e.g., SHA-256, SHA-3), McEliece cryptography, bit flipping key encapsulation (BIKE), Hamming quasi-cycling (HQC) encryption, hash-based message authentication code (e.g., HMAC-512), RNG seeding. In some cases, multiple cryptographical functional blocks 911 can be connected to one another directly or indirectly. In some implementations, the one or more cryptographical functional blocks 911 can include one or more co-processing units.

Processor 910 may include any general purpose processor and a hardware service or software service, such as services 932, 934, and 936 stored in storage device 930, configured to control processor 910 as well as a special-purpose processor (e.g., an arithmetic processor, a cryptographic processor, and/or any combination thereof) where software instructions are incorporated into the actual processor design. Processor 910 may essentially be a completely self-contained computing system, containing multiple cores or processors, a bus, memory controller, cache, etc. A multi-core processor may include distinct computation units of variable sizes and features. In some cases, a multi-core processor may be symmetric or asymmetric. In some examples, the one or more cryptographical functional blocks 911 may be symmetric or asymmetric.

To enable user interaction, computing system 900 includes an input device 945, which may represent any number of input mechanisms, such as a microphone for speech, a touch-sensitive screen for gesture or graphical input, keyboard, mouse, motion input, speech, etc. computing system 900 may also include output device 935, which may be one or more of a number of output mechanisms. In some instances, multimodal systems may enable a user to provide multiple types of input/output to communicate with computing system 900.

computing system 900 may include communications interface 940, which may generally govern and manage the user input and system output. The communications interface 940 may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 940 may also include one or more Global Navigation Satellite System (GNSS) receivers or transceivers that are used to determine a location of the computing system 900 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 930 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 930 may include software services, servers, services, etc., that when the code that defines such software is executed by the processor 910, it causes the system to perform a function. In some embodiments, a hardware service that performs a particular function may include the software component stored in a computer-readable medium in connection with the necessary hardware components, such as processor 910, connection 905, output device 935, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, nonvolatile memory express (NVMe) memory, Write Once Read Many (WORM) memory, electronic fuse (eFuse) one-time programmable (OTP), memory, I-fuse OTP memory, gate-oxide breakdown anti-fuse memory, Intel Optane memory, memory, or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the embodiments and examples provided herein, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual embodiments may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some embodiments the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communications interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communications interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for sensing light comprising: a cross-connected node; an output node; a reset circuit comprising: a reset input node coupled to a reset signal; and a reset output node coupled to the cross-connected node; a photosensitive element coupled to at least one of the cross-connected node or the output node and configured to generate a photocurrent in response to light; an electrical component coupled between the cross-connected node and the output node, wherein, in response to receiving an active state of the reset signal at the reset input node, the electrical component is configured to latch a voltage of the output node at a first voltage and a voltage of the cross-connected node at a second voltage, different from the first voltage and wherein, in response to at least one of the cross-connected node falling below a first threshold voltage or the output node rising above a second threshold voltage, latching a third voltage at the output node, the third voltage being different from the first voltage.

Aspect 2. The apparatus for sensing light of Aspect 1, wherein: the electrical component comprises a NAND gate and an inverter; the reset signal is coupled to a first input of the NAND gate; the output node is coupled to a second input of the NAND gate; an output of the NAND gate is coupled to the cross-connected node; an input of the inverter is coupled to the cross-connected node; and an output of the inverter is coupled to the output node.

Aspect 3. The apparatus for sensing light of any of Aspects 1 to 2, wherein: a photocurrent generated by the photosensitive element is configured to pull-up the output node in response to light; and a pull-down N-channel metal-oxide semiconductor (NMOS) transistor of the inverter is configured to have a lower pull-down strength than first and second NMOS transistors of the NAND gate.

Aspect 4. The apparatus for sensing light of any of Aspects 1 to 3, wherein: a photocurrent generated by the photosensitive element is configured to pull-down the cross-connected node in response to light; and a first pull-up P-channel metal-oxide semiconductor (PMOS) transistor of the NAND gate is configured to pull-up the voltage of the cross-connected node to the first voltage when the voltage of the output node is at the second voltage, wherein the first pull-up PMOS transistor is configured to have a lower pull-up strength than at least one of a second pull-up PMOS transistor of the NAND gate or a third pull-up PMOS transistor of the inverter, wherein the second pull-up PMOS transistor is configured to pull-up the cross-connected node when the reset signal is active,.

Aspect 5. The apparatus for sensing light of any of Aspects 1 to 4, wherein the photosensitive element comprises one or more of NMOS diodes, PMOS diodes, PN junctions, or photopixels.

Aspect 6. The apparatus for sensing light of any of Aspects 1 to 5, further comprising an OR gate, wherein a first input of the OR gate is coupled to the output node, a second input of the OR gate is coupled to a fault detection feed-through signal, and an output of the OR gate outputs a fault detection output signal.

Aspect 7. The apparatus for sensing light of any of Aspects 1 to 6, wherein the fault detection feed-through signal is coupled to an additional fault detection output signal of an additional apparatus for sensing light.

Aspect 8. The apparatus for sensing light of any of Aspects 1 to 7, further comprising an edge detection module, wherein the edge detection module is configured to detect a rising voltage of the output node.

Aspect 9. The apparatus of any of Aspects 1 to 8, wherein, based on detecting the rising voltage of the output node, the edge detection module is configured to initiate a defensive measure for a computing device.

Aspect 10. The apparatus of any of Aspects 1 to 9, wherein the defensive measure comprises one or more of rebooting or powering down the computing device.

Aspect 11. The apparatus of any of Aspects 1 to 10, wherein the computing device comprises a cryptographic processor.

Aspect 12. A method for sensing light comprising: obtaining an active state of a reset signal at a reset input node of an electrical component; in response to obtaining the active state of the reset signal, latching a voltage of an output node of the electrical component at a first voltage and latch a voltage of a cross-connected node of the electrical component at a second voltage, different from the first voltage; obtaining a photocurrent generated by a photosensitive element coupled to at least one of the cross-connected node or the output node; and in response to at least one of the cross-connected node falling below a first threshold voltage or the output node rising above a second threshold voltage, latching a third voltage at the output node, the third voltage being different from the first voltage.

Aspect 13. The method for sensing light of Aspect 12, wherein the photosensitive element comprises one or more of NMOS diodes, PMOS diodes, PN junctions, or photopixels.

Aspect 14. The method for sensing light of any of Aspects 12 to 13, further comprising outputting a fault detection output signal, wherein the fault detection output signal based on a combination of a voltage of the output node and a fault detection feed-through signal.

Aspect 15. The method for sensing light of any of Aspects 12 to 14, further comprising detecting, by an edge detection module, a rising voltage of the output node.

Aspect 16. The method for sensing light of any of Aspects 12 to 15, further comprising, based on detecting the rising voltage of the output node, initiating a defensive measure for a computing device.

Aspect 17. The method for sensing light of any of Aspects 12 to 16, wherein the defensive measure comprises one or more of rebooting or powering down the computing device.

Aspect 18. An apparatus for sensing laser fault injection (LFI) attacks comprising: a plurality of logic gates; a plurality of LFI sensing circuits distributed among the plurality of logic gates, wherein the plurality of LFI sensing circuits are configured to output a fault detection output based on detection an LFI attack; and an edge detection module configured to determine whether a fault detection output of the plurality of LFI sensing circuits are indicative of an LFI attack and to initiate a defensive measure for a computing device based on a determination that the fault detection output of the plurality of LFI sensing circuits are indicative of an LFI attack.

Aspect 19. The apparatus for sensing LFI attacks of Aspect 18, wherein the defensive measure comprises one or more of rebooting or powering down a computing device.

Aspect 20. The apparatus for sensing LFI attacks of any of Aspects 18 to 19, wherein determine whether the fault detection output of the plurality of LFI sensing circuits is indicative of an LFI attack comprises detecting a rising voltage of the fault detection output of the plurality of LFI sensing circuits.

Aspect 21. The apparatus for sensing LFI attacks of any of Aspects 18 to 20, wherein the plurality of logic gates is arranged in an array and wherein the plurality of LFI sensing circuits are distributed within the array.

Aspect 22. The apparatus for sensing LFI attacks of any of Aspects 18 to 21, wherein the plurality of LFI sensing circuits are arranged in a rectangular array.

Aspect 23. The apparatus for sensing LFI attacks of any of Aspects 18 to 22, wherein each LFI sensing circuit has a corresponding sensing area covering a subset of the plurality of logic gates, and wherein a distribution of corresponding sensing areas of the plurality of LFI sensing circuits is configured to collectively cover every logic gate of the plurality of logic gates.

Aspect 24. The apparatus for sensing LFI attacks of any of Aspects 18 to 23, wherein the edge detection module is coupled to a fault detection output of a final LFI sensing circuit of the plurality of LFI sensing circuits, wherein respective fault detection outputs of the plurality of LFI sensing circuits are serially connected such that the edge detection module can determine that an LFI attack was detected by any LFI sensing circuit of the plurality of LFI sensing circuits based on the fault detection output of the final LFI sensing circuit of the plurality of LFI sensing circuits.

Aspect 25. The apparatus for sensing LFI attacks of any of Aspects 18 to 24, wherein the plurality of logic gates and the plurality of LFI sensing circuits are included in a computing device.

Aspect 26. The apparatus for sensing LFI attacks of any of Aspects 18 to 25, wherein the computing device comprises a cryptographic processor.

Aspect 27. The apparatus for sensing LFI attacks of any of Aspects 18 to 26, wherein the plurality of LFI sensing circuits are included within a secure perimeter of the computing device.

Aspect 28. An apparatus for sensing light comprising: a latch configured to obtain a reset input and output a first voltage at an output node based on the reset input; and a photosensitive element configured to generate a photocurrent at one or more of the output node of the latch or a cross-connected node of the latch, wherein the latch is configured to latch, based on the photocurrent generated at one or more of the output node of the latch or the cross-connected node of the latch, a second voltage at the output node, wherein the second voltage is different from the first voltage.

Aspect 29. The apparatus for sensing light of Aspect 28, wherein the photosensitive element comprises one or more of NMOS diodes, PMOS diodes, PN junctions, or photopixels.

Aspect 30. The apparatus for sensing light of any of Aspects 28 to 29, further comprising an edge detection module, wherein the edge detection module is configured to detect a rising voltage of the output node.

Aspect 31: A non-transitory computer-readable storage medium having stored thereon instructions which, when executed by one or more processors, cause the one or more processors to perform any of the operations of aspects 1 to 30.

Aspect 32. An apparatus comprising means for performing a method according to any of Aspects 1 to 30.

What is claimed is:

1. An apparatus for sensing light comprising:
a cross-connected node;
an output node;
a reset circuit comprising:
a reset input node coupled to a reset signal; and
a reset output node coupled to the cross-connected node;
a photosensitive element coupled to at least one of the cross-connected node or the output node and configured to generate a photocurrent in response to light; and
an electrical component coupled between the cross-connected node and the output node, wherein, in response to receiving an active state of the reset signal at the reset input node, the electrical component is configured to latch a voltage of the output node at a first voltage and a voltage of the cross-connected node at a second voltage, different from the first voltage and wherein, in response to at least one of the cross-connected node falling below a first threshold voltage or the output node rising above a second threshold voltage, latching a third voltage at the output node, the third voltage being different from the first voltage.

2. The apparatus for sensing light of claim 1, wherein:
the electrical component comprises a NAND gate and an inverter;
the reset signal is coupled to a first input of the NAND gate;
the output node is coupled to a second input of the NAND gate;
an output of the NAND gate is coupled to the cross-connected node;
an input of the inverter is coupled to the cross-connected node; and
an output of the inverter is coupled to the output node.

3. The apparatus for sensing light of claim 2, wherein:
a photocurrent generated by the photosensitive element is configured to pull-up the output node in response to light; and
a pull-down N-channel metal-oxide semiconductor (NMOS) transistor of the inverter is configured to have a lower pull-down strength than first and second NMOS transistors of the NAND gate.

4. The apparatus for sensing light of claim 2, wherein:
a photocurrent generated by the photosensitive element is configured to pull-down the cross-connected node in response to light; and
a first pull-up P-channel metal-oxide semiconductor (PMOS) transistor of the NAND gate is configured to pull-up the voltage of the cross-connected node to the first voltage when the voltage of the output node is at the second voltage, wherein the first pull-up PMOS transistor is configured to have a lower pull-up strength than at least one of a second pull-up PMOS transistor of the NAND gate or a third pull-up PMOS transistor of the inverter, wherein the second pull-up PMOS transistor is configured to pull-up the cross-connected node when the reset signal is active,.

5. The apparatus for sensing light of claim 1, wherein the photosensitive element comprises one or more of NMOS diodes, PMOS diodes, PN junctions, or photopixels.

6. The apparatus for sensing light of claim 1, further comprising an OR gate, wherein a first input of the OR gate is coupled to the output node, a second input of the OR gate is coupled to a fault detection feed-through signal, and an output of the OR gate outputs a fault detection output signal.

7. The apparatus for sensing light of claim 6, wherein the fault detection feed-through signal is coupled to an additional fault detection output signal of an additional apparatus for sensing light.

8. The apparatus for sensing light of claim 1, further comprising an edge detection module, wherein the edge detection module is configured to detect a rising voltage of the output node.

9. The apparatus of claim 8, wherein, based on detecting the rising voltage of the output node, the edge detection module is configured to initiate a defensive measure for a computing device.

10. The apparatus of claim 9, wherein the defensive measure comprises one or more of rebooting or powering down the computing device.

11. The apparatus of claim 9, wherein the computing device comprises a cryptographic processor.

12. A method for sensing light comprising:
obtaining an active state of a reset signal at a reset input node of an electrical component;
in response to obtaining the active state of the reset signal, latching a voltage of an output node of the electrical component at a first voltage and latch a voltage of a cross-connected node of the electrical component at a second voltage, different from the first voltage;
obtaining a photocurrent generated by a photosensitive element coupled to at least one of the cross-connected node or the output node; and
in response to at least one of the cross-connected node falling below a first threshold voltage or the output node rising above a second threshold voltage, latching a third voltage at the output node, the third voltage being different from the first voltage.

13. The method for sensing light of claim 12, wherein the photosensitive element comprises one or more of NMOS diodes, PMOS diodes, PN junctions, or photopixels.

14. The method for sensing light of claim 12, further comprising outputting a fault detection output signal, wherein the fault detection output signal based on a combination of a voltage of the output node and a fault detection feed-through signal.

15. The method for sensing light of claim 12, further comprising detecting, by an edge detection module, a rising voltage of the output node.

16. The method for sensing light of claim 15, further comprising, based on detecting the rising voltage of the output node, initiating a defensive measure for a computing device.

17. The method for sensing light of claim 16, wherein the defensive measure comprises one or more of rebooting or powering down the computing device.

18. An apparatus for sensing laser fault injection (LFI) attacks comprising:
a plurality of logic gates;
a plurality of LFI sensing circuits distributed among the plurality of logic gates, wherein the plurality of LFI sensing circuits are configured to output a fault detection output based on detection an LFI attack; and
an edge detection module configured to determine whether a fault detection output of the plurality of LFI sensing circuits are indicative of an LFI attack and to initiate a defensive measure for a computing device based on a determination that the fault detection output of the plurality of LFI sensing circuits are indicative of an LFI attack.

19. The apparatus for sensing LFI attacks of claim 18, wherein the defensive measure comprises one or more of rebooting or powering down a computing device.

20. The apparatus for sensing LFI attacks of claim 18, wherein determine whether the fault detection output of the plurality of LFI sensing circuits is indicative of an LFI attack comprises detecting a rising voltage of the fault detection output of the plurality of LFI sensing circuits.

21. The apparatus for sensing LFI attacks of claim 18, wherein the plurality of logic gates is arranged in an array and wherein the plurality of LFI sensing circuits are distributed within the array.

22. The apparatus for sensing LFI attacks of claim 21, wherein the plurality of LFI sensing circuits are arranged in a rectangular array.

23. The apparatus for sensing LFI attacks of claim 21, wherein each LFI sensing circuit has a corresponding sensing area covering a subset of the plurality of logic gates, and wherein a distribution of corresponding sensing areas of the plurality of LFI sensing circuits is configured to collectively cover every logic gate of the plurality of logic gates.

24. The apparatus for sensing LFI attacks of claim 18, wherein the edge detection module is coupled to a fault detection output of a final LFI sensing circuit of the plurality of LFI sensing circuits, wherein respective fault detection outputs of the plurality of LFI sensing circuits are serially connected such that the edge detection module can determine that an LFI attack was detected by any LFI sensing circuit of the plurality of LFI sensing circuits based on the fault detection output of the final LFI sensing circuit of the plurality of LFI sensing circuits.

25. The apparatus for sensing LFI attacks of claim 18, wherein the plurality of logic gates and the plurality of LFI sensing circuits are included in a computing device.

26. The apparatus for sensing LFI attacks of claim 25, wherein the computing device comprises a cryptographic processor.

27. The apparatus for sensing LFI attacks of claim 25, wherein the plurality of LFI sensing circuits are included within a secure perimeter of the computing device.

28. An apparatus for sensing light comprising:
a latch configured to obtain a reset input and output a first voltage at an output node based on the reset input; and
a photosensitive element configured to generate a photocurrent at one or more of the output node of the latch or a cross-connected node of the latch, wherein the latch is configured to latch, based on the photocurrent generated at one or more of the output node of the latch or the cross-connected node of the latch, a second voltage at the output node, wherein the second voltage is different from the first voltage.

29. The apparatus for sensing light of claim 28, wherein the photosensitive element comprises one or more of NMOS diodes, PMOS diodes, PN junctions, or photopixels.

30. The apparatus for sensing light of claim 28, further comprising an edge detection module, wherein the edge detection module is configured to detect a rising voltage of the output node.
